(19) United States
(12) Patent Application Publication
(10) Pub. No.: US 2005/0188551 A1
(43) Pub. Date: Sep. 1, 2005

(54) Illuminating brake release for a motor chain saw

(76) Inventors: Thomas R. Magnuson, Chico, CA (US); James R. Wills, Chico, CA (US); Jess R. Wills, Durham, CA (US)

Correspondence Address: MCDONOUGH, HOLLAND & ALLEN, 555 CAPITOL MALL, 9TH FLOOR, SACRAMENTO, CA, 95814, US

(21) Appl. No.: 10/791,430

(22) Filed: Mar. 1, 2004

(51) Int. Cl. B27B 17/00

(52) U.S. Cl. 30/382; 30/383

(57) ABSTRACT

A motor chain saw having a light source positioned at the front of the brake release handle of the brake release positioned for illuminating the saw chain in operation.

### BACKGROUND OF THE INVENTION

1. Field of the Invention

The present invention relates to motor chain saws, and, in particular, to a motor chain saw brake release handle with a light source.

2. Description of Related Art

U.S. patent application 20020054491-A1, to Casas, published May 9, 2002, discloses a lighting apparatus for tools as a new and improved apparatus for use on a variety of hand-held tools, including a chain saw. The application shows a small light mounted at the top of a variety of hand-held tools, with a mounting means used to properly affix the light to the power tool. The light projects a beam of light in a forward direction for working in poorly lighted areas. The application describes a light that would preferably be designed to be battery-powered, but could also be hooked up to batteries in the attached hand tool, or to a standard household current.

Casas, et al., disclose mounting such a light on the forward handle of a chain saw. Mounting such a light on a brake release handle of a chain saw is inconsistent with the intended use of the forward handle as a chain saw brake release, however. Most chain saws come with braking systems designed to cut off the operation of the saw, in particular the movement of the saw chain, to reduce the risk of injury in certain circumstances U.S. Pat. No. 4,370,810, to Schurr, et al., issued Feb. 1, 1983, describes such a chain saw, a portable motor chain saw with a braking device for stopping the saw chain during recoil, and with a release for the braking device, which in the release position is operatively connected with a locking mechanism of the braking device. The release has an inertial mass freely movable along an acceleration path, with the kinetic energy of the inertial mass in the release position being greater than the resistance force of the locking mechanism. The release is held in the ready position by at least one holder, preferably a spring which extends between the saw housing and the release.

U.S. Pat. No. 4,683,660, to Schurr, issued Aug. 4, 1987, discloses a braking arrangement for a motor-driven chain saw. The braking arrangement is actuable by a releasing device and is held in the release position against a spring force by means of a latching device. The braking arrangement includes a brake band holding member to which a brake band is fastened. The brake band can be tightened around a clutch drum of the motor-driven chain saw by means of an ancillary chain brake device provided in addition to the chain brake device, so that the clutch drum is brought to an immediate stop. This braking action occurs also if the releasing device of the chain brake device is not actuated. In this way, the chain brake device remains activated enabling it to act during operation of the chain saw, for example, in the event that the motor-driven chain saw kicks back while the saw chain is running.

The application of considerable force is required to release the chain brake using the brake release handle designs of the prior art, by pulling the handle back to the chain saw. A light mounted on such a brake release handle, as disclosed by Casas, et al., would interfere with the normal operation of the chain saw.

The problem of providing a safe, reliable means for illuminating the cutting saw chain of a motor chain saw is complicated, too, given the harsh uses of a chain saw, which includes heavy and dangerous work in fire and forest service situations. Generally, as chain saws have become more sophisticated tools, they have increasingly been produced with advanced materials to reduce weight, while durable enough to survive the rigors of chain saw operation. Chain saw designs are typically sleek in profile, avoiding extraneous matter that can be broken off, caught on vegetation, debris, etc..

Lightweight, high-tech polymers are now commonly employed that can withstand greater impact, and are corrosion-resistant. Exteriors are streamlined to reduce clogging and are easy to clean, while the handles are contoured and/or coated for a secure grip, and ergonomically angled for comfort. Improved designs continue to emphasize safety and ease of operation, with minimal extraneous matter in their construction that might snag on clothing or break off in operation.

With the vibration and rough treatment given a chain saw in normal operation makes it impossible to consider any component that would have a high rate of failure and require replacement under the normal conditions of use. There remains a need, then, for a motor chain saw that can be safely operated in the dark, and that has a source of illumination that is cost effective, safe, and reliable.

### SUMMARY OF THE INVENTION

The present invention provides an improved brake release, and a motor chain saw having a light source in the brake release operatively positioned for illuminating the saw chain while in operation. The brake release comprises a brake release handle secured to the chain saw and disposed between the chain saw handle and the saw blade of the chain saw, the brake release handle having a front wall facing the saw chain, and a rear wall, with the light source emanating from the front wall to illuminate at least a portion of the saw chain while in operation.

In one preferred embodiment, the motor chain saw comprises a main motor housing having a braking mechanism for stopping the motion of the saw chain, wherein the brake release further comprises an extension engageable with the braking mechanism of the housing, and wherein the brake release handle is manually operable to a brake release position, or ready position, from a braking position where the extension is engaged and the braking mechanism has stopped the motion of the saw chain.

Preferably, the front wall comprises a translucent material, with the light source protected and secured behind the translucent material. In one such embodiment, the front wall comprises a cover reversibly attached to the brake release handle.

Preferably, the translucent material of the brake release handle is a durable and scratch resistant material, such as a plastic like plexiglass. Other translucent materials may be used, including durable and/or shatter-resistant glass.

In a preferred construction, the light source is affixed to a plate secured within the brake release handle, such as by being attached to an interior surface of the rear wall. A power source for supplying electricity to the light source may also be located within the brake release handle, such as at least one battery. For convenience the battery may also be secured to the light plate.

In an alternative embodiment, the power source is connected to the housing. In one preferred embodiment the power source is connected to the magneto of the motor chain saw, with a transformer for adapting electricity from the magneto to a voltage appropriate for the light source.

In a further preferred embodiment, the light source comprises a light that is resistant to vibration, such as a light-emitting diode. In an even further preferred embodiment, the light source comprises two or more lights, such as light-emitting diodes.

The brake release handle further preferably comprises a switch for activating the light source, which can be conveniently located in the rear wall of the brake release handle, for ease of access by the operator of the motor chain saw.

These and other features and advantages of this invention are described in, or are apparent from, the following detailed description of various exemplary embodiments of the apparatus and methods according to this invention.

### BRIEF DESCRIPTION OF THE DRAWINGS

Various exemplary embodiments of this invention will be described in detail, with reference to the following figures, wherein:

FIG. 1 is an exploded view of the illuminating brake release handle;

FIG. 2 is a perspective view of the assembled brake release handle;

FIG. 3 is a front elevation of an assembled illuminating brake release handle;

FIG. 4 is a side elevation of the assembled brake release handle; and

FIG. 5 is a perspective view of the light mounting plate of the brake release handle.

### DETAILED DESCRIPTION OF THE PREFERRED EMBODIMENT

In order to be able to safely guide a motor chain saw during the sawing procedure, a main motor housing is typically provided. The blade and the saw chain that is driven by the motor and that supported on the blade, emanate from this main motor housing. A rear grip or handle of the main motor housing has the control elements for the internal combustion machine, and a front grip or handle is secured thereto. The front handle extends, along its middle section, transverse to the cutting plane of the saw chain, and is arranged above the center of gravity of the saw (not illustrated in the drawings) in the vertical cutting position of the saw.

The motor housing has a braking mechanism for stopping the motion of the saw chain. The brake release generally comprises a brake release handle secured to the chain saw and disposed between the chain saw handle and the saw blade of the chain saw, the brake release handle having a front wall facing the saw chain, and a rear wall. The brake release also has an extension for securing the brake release to the motor housing, and also has an extension that is engageable with the braking mechanism of the housing. Such a motor chain saw is described in U.S. Pat. No. 4,683,660, to Schurr, issued Aug. 4, 1987.

The release or triggering mechanism of such braking devices places the brake release handle at a slight distance from the handle, between the handle and the saw chain. The brake release handle is pivotally journalled by a bearing or support part screwed thereto, about an axis located on the motor housing, and formed by a pin extending parallel to the motor-axis of rotation. In the ready position, or brake release position, the brake release handle has a spacing that is closer to the handle, while in situations where the braking mechanism is engaged, it is rotated and shifted further from the handle, and closer to the saw blade.

In situations where the chain brake system has been activated the brake release handle is repositioned while the brake mechanism stops the chain. To release the brake mechanism, the brake release handle of the brake release is pulled back toward the handle, to the release, or ready position.

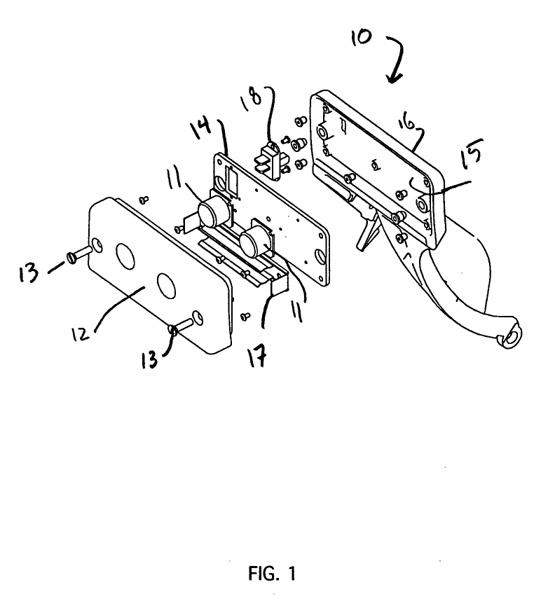

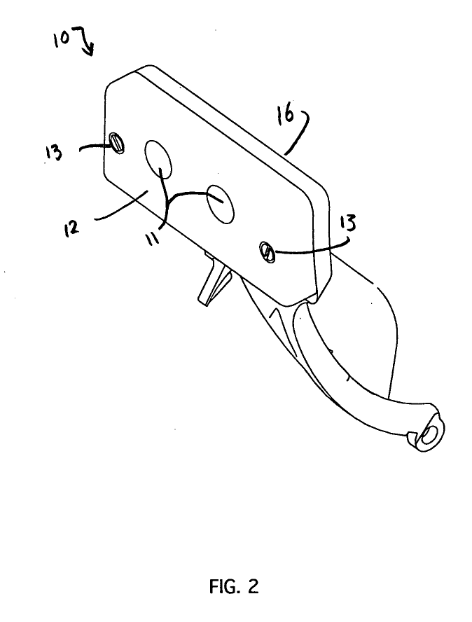

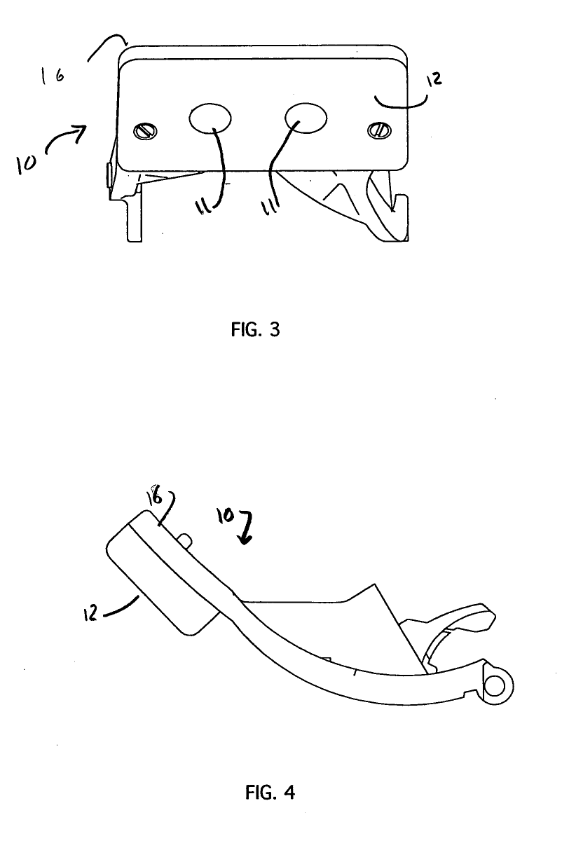

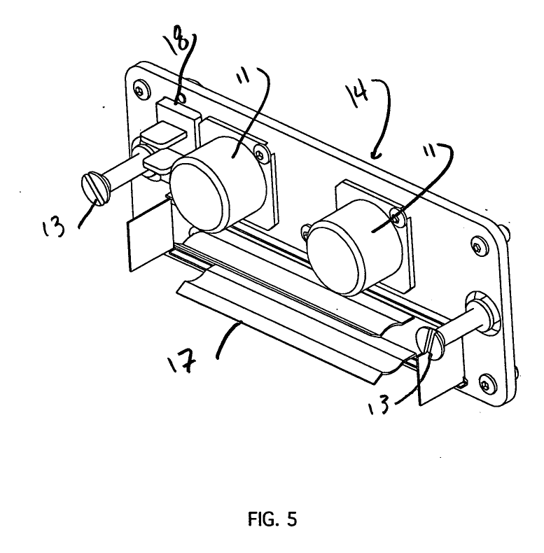

The motor chain saw of the present invention is characterized in that the chain brake release or triggering device holds a light source that is directed over the cutting region of the saw chain (FIG. 1). FIGS. 2 through 4 show the brake release of the invention 10, assembled in the mode for attachment to a motor chain saw (not shown).

In operation of the brake release, the brake release handle 10 is manually operable to a brake release position, or ready position, from a braking position, where in the latter position the extension is engaged and the braking mechanism has stopped the motion of the saw chain.

The brake release 10 described herein has a light source 11 located in the brake release operatively positioned for illuminating the saw chain while in operation, with the light source emanating from the front wall 12 to illuminate at least a portion of the saw chain while in operation. Preferably, the front wall 12 comprises a translucent material, with the light source 11 protected and secured behind the translucent material.

The front wall 12 can be a cover reversibly attached to the brake release handle 10 in a conventional manner. In FIG. 1 it is seen that the front wall can be secured to the brake release handle by means of screws 13.

The translucent material of the front wall 12 is a durable and scratch resistant material, such as a plastic like plexiglass. Other translucent materials may be used, including durable and/or shatter-resistant glass. The front wall 12 will experience forces ranging from debris encounted by the chain saw in operation, as well as the force of an operator pulling the handle back to the main housing to release the chain brake.

The light source 12 is affixed within the brake release handle 10. FIG. 1 shows a plate 14 secured within the brake release handle by being attached to an interior surface 15 of the rear wall 16. A power source for supplying electricity to the light source may also be located within the brake release handle, such as at least one battery. For convenience the battery can also be secured to a site 17 affixed to the mounting plate 14, as shown in FIG. 5, though the battery may be located in any suitable recess or other location of the brake release handle 10. It is best if the battery can be replaceable without replacing the light source 11, however, as the light source may last many generations of the typical battery.

In an alternative embodiment, the power source is connected to the housing. In one preferred embodiment the power source is connected to the magneto of the motor chain saw, with a transformer for adapting electricity from the magneto to a voltage appropriate for the light source. In an conventional manner, wires may be run through either extension to a connector in the motor housing (not shown) for establishing a connection between the light and a power source in the housing.

The brake release handle further preferably comprises a switch 18 for activating the light source, which can be conveniently be located in the rear wall 16of the brake release handle, for ease of access by the operator of the motor chain saw (FIG. 5).

In a further preferred embodiment, the light source 11 comprises a light that is resistant to vibration, such as a light emitting diode. In an even further preferred embodiment, the light source 11 comprises two or more lights, such as light emitting diodes.

LED based light sources last at least 10 times longer than a normal light source, so there is no need to replace the light source, reducing or even eliminating ongoing maintenance costs and periodic re-lamping expenses. There is no point in time at which a LED light source ceases to function; instead, LEDs gradually degrade in performance over time. LED lights can last up to 10 years or 100,000 hours. The higher quality products, for example, will have an average of 70% of initial intensity after 50,000 hours of operation. In an application where the light source would be used for 12 hours per day, 365 days per year, this would result in a system lifetime of over 11 years with only a 30% degradation (70% lumen maintenance) from initial luminous output and no catastrophic failures. Numerous simple operations to replace the battery will take place before a new mounting plate with new LED lights will be required.

The light emitted from an LED is directional. Typical conventional sources such as incandescent, halogen, or fluorescent lights are omni-directional, emitting light in all directions. Additionally, the LED light provides a high power white light source that is easy on the eyes for long operation in a poorly lit environment. Thus, an LED light will generate light only in the range that a person can see, and only where it is needed.

A 1.2 watt white LED light cluster is as bright as a 20-watt incandescent lamp (bright enough to read by). It is also more rugged than halogen or fluorescent alternatives. The small size of the LED light source also allows for a compact design, and two such lights easily fit into the dimensions of a typical brake release.

LEDs are vibration-proof, with solid state lighting containing no moving parts and no filaments to break. As such, LEDs handle rough environments including heavy vibration and impact, with no fragile glass components, and no mercury or toxic gasses. There is nothing to break, rupture, shatter, leak, or contaminate. The solid state nature of LEDs make them extremely rugged and durable. With no fragile components to break, they are ideal for the rugged conditions of chain saw operation, while providing a reliable, long-lasting light source.

Another advantage of LEDs is that the solid state technology will start at temperatures down to as low as 40° C. This cold start ability allows for instant on/off control without specially designed circuitry, simplifying the design and lowering the drain on the power source.

Various elements of the brake release are replaceable, and may be sold with or without original saw, or with or without a package of the fully assembled brake release.

The internal plate 14 for mounting the light source 11 is replaceable, generally with the light source 11 as a replaceable unit.

The front wall 12, or lens cover, is also separately replaceable, as it may become damaged in use from debris or rough treatment, thereby reducing the efficiency of the illumination from the light source 11.

The present invention provides a great improvement the brake release of a motor chain saw, and allows the motor chain saw to be operated under poorly lighted situations in a more safe manner.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

1. A brake release for a motor chain saw, said brake release having a brake release handle secured to the chain saw and disposed between the chain saw handle and the saw blade of the chain saw, said brake release handle operatively connected to a brake capable of stopping the motion of the saw chain and moveable between a braking position and a ready position whereby said brake is released, said brake release handle manually operable to said brake release position from said braking position,
wherein said brake release handle has a front wall facing the saw chain, and a rear wall, and
wherein said brake release handle has a light source emanating from said front wall illuminating at least a portion of said saw chain when said brake release is in said ready position.

2. The brake release of claim 1, wherein said chain saw comprises a main motor housing having a braking mechanism for stopping said motion of said saw chain, and wherein said brake release further comprises an extension engageable with said braking mechanism of said housing.

3. The brake release of claim 1, wherein said front wall comprises a translucent material.

4. The brake release of claim 3, wherein said light source is secured behind said translucent material.

5. The brake release of claim 3, wherein said front wall comprises a cover reversibly attached to said brake release handle.

6. The brake release of claim 3, wherein said translucent material is plastic.

7. The brake release of claim 5, wherein said plastic is plexiglass.

8. The brake release of claim 3, wherein said translucent material is glass.

9. The brake release of claim 1, wherein said light source is affixed to a plate secured within said brake release handle.

10. The brake release of claim 9, wherein said plate is attached to an interior surface of said rear wall.

11. The brake release of claim 1, further comprising a power source for supplying electricity to said light source.

12. The brake release of claim 11, wherein said power source is located within said brake release handle.

13. The brake release of claim 11, wherein said power source comprises at least one battery.

14. The brake release of claim 11, wherein said power source is connected to said housing.

15. The brake release of claim 14, wherein said power source is connected to the magneto of said motor chain saw.

16. The brake release of claim 15, wherein said power source further comprises a transformer for adapting electricity from said magneto to a voltage appropriate for said light source.

17. The brake release of claim 1, wherein said light source comprises a light emitting diode.

18. The brake release of claim 17, wherein said light source comprises two or more light emitting diodes.

19. The brake release of claim 1, wherein said brake release handle further comprises a switch for activating said light source.

20. The brake release of claim 19, wherein said switch is located in said rear wall.

21. A motor chain saw having a light source in the brake release operatively positioned for illuminating the saw chain while in operation,
wherein said brake release comprises a brake release handle secured to the chain saw and disposed between the chain saw handle and the saw blade of the chain saw, said brake release handle having generally planar front wall facing toward the saw chain, and a rear wall, and
wherein said light source emanates from said front wall to illuminate at least a portion of said saw chain while in operation.

22. The motor chain saw of claim 21, further comprising a main motor housings having a braking mechanism for stopping the motion of said saw chain,
wherein said brake release further comprises an extension engageable with said braking mechanism of said housing, and
wherein said brake release handle is manually operable to a brake release position from a braking position.

23. The motor chain saw of claim 21, wherein said front wall comprises a translucent material.

24. The motor chain saw of claim 23, wherein said light source is secured behind said translucent material.

25. The motor chain saw of claim 23, wherein said front wall comprises a cover reversibly attached to said brake release handle.

26. The motor chain saw of claim 23, wherein said translucent material is plastic.

27. The motor chain saw of claim 25, wherein said plastic is plexiglass.

28. The motor chain saw of claim 23, wherein said translucent material is glass.

29. The motor chain saw of claim 21, wherein said light source is affixed to a plate secured within said brake release handle.

30. The motor chain saw of claim 29, wherein said plate is attached to an interior surface of said rear wall.

31. The motor chain saw of claim 21, further comprising a power source for supplying electricity to said light source.

32. The motor chain saw of claim 31, wherein said power source is located within said brake release handle.

33. The motor chain saw of claim 31, wherein said power source comprises at least one battery.

34. The motor chain saw of claim 31, wherein said power source is connected to said housing.

35. The motor chain saw of claim 34, wherein said power source is connected to the magneto of said motor chain saw.

36. The motor chain saw of claim 35, wherein said power source further comprises a transformer for adapting electricity from said magneto to a voltage appropriate for said light source.

37. The motor chain saw of claim 11, wherein said light source comprises a light emitting diode.

38. The motor chain saw of claim 37, wherein said light source comprises two or more light emitting diodes.

39. The motor chain saw of claim 21, wherein said brake release handle further comprises a switch for activating said light source.

40. The motor chain saw of claim 39, wherein said switch is located in said rear wall.
